(19) United States
(12) Patent Application Publication
(10) Pub. No.: US 2012/0000370 A1
(43) Pub. Date: Jan. 5, 2012

(54) APPARATUS FOR MAKING A HOT DRINK

(76) Inventor: Joerg Krug, Steffenberg (DE)

(21) Appl. No.: 13/171,656

(22) Filed: Jun. 29, 2011

(30) Foreign Application Priority Data
Jul. 3, 2010 (DE) 102010026017.7

(51) Int. Cl. A47J 31/44

(52) U.S. Cl. 99/279

(57) ABSTRACT

An electric coffee machine has a housing, a brewing unit in the housing having an outlet from which used grounds are ejected, a removable receptacle in the housing spaced below the outlet and adapted to receive the ejected used grounds, and a removable funnel-shaped liner in the housing between the outlet and the receptacle. This liner surrounds a pathway traveled by the used grounds when moving from the outlet to the receptacle so that the liner protects the machine from being soiled by the used grounds when moving from the outlet to the receptacle.

### FIELD OF THE INVENTION

The present invention relates to an apparatus for making a hot drink. More particularly this invention concerns a coffee machine.

### BACKGROUND OF THE INVENTION

A standard apparatus for preparing hot beverages, in particular an electric coffee machine, has a housing holding functional components such as a brewing unit or module that takes in ground coffee beans, forms it into a tablet or cake, and then brews from this tablet or cake a portion of coffee. The cake of used grounds is then ejected from an outlet of the brewing unit into a receptacle that, when full, is removed from the machine for disposal of the used grounds.

In particular, the machine forces hot fresh water and/or steam through the cake so as to produce the desired beverage, forming the desired infusion from what the water extracts from the cake. The finished beverage is typically delivered to the user at the front of the machine, whereupon the machine ejects the used cake of coffee grounds into the waste receptacle. Typically a large number of these used cakes can be held in the receptacle that only needs to be emptied after many uses of the machine.

A disadvantage of this arrangement is that a relatively large free space (clearance) exists between the outlet of the brewing module where the used grounds are discharged and the used grounds receptacle, thereby allowing elements in the machine housing to be soiled by the used grounds discharged from the brewing module. This soiling of the machine's internal parts is an unwanted effect since these parts are essentially inaccessible and can be cleaned only with difficulty, if at all.

### OBJECTS OF THE INVENTION

It is therefore an object of the present invention to provide an improved beverage-making apparatus.

Another object is the provision of an improved coffee machine that overcomes the above-given disadvantages, in particular in which soiling of housing's internal parts caused by the used grounds discharged from the brewing module to the used grounds receptacle is largely prevented.

### SUMMARY OF THE INVENTION

An electric coffee machine has according to the invention a housing, a brewing unit in the housing having an outlet from which used grounds are ejected, a removable receptacle in the housing spaced below the outlet and adapted to receive the ejected used grounds, and a removable funnel-shaped liner in the housing between the outlet and the receptacle. This liner surrounds a pathway traveled by the used grounds when moving from the outlet to the receptacle so that the liner protects the machine from being soiled by the used grounds when moving from the outlet to the receptacle.

The liner is disposed between the outlet and the used grounds receptacle such that the used grounds discharged from the brewing module are shielded externally by the walls of the funnel-like liner, in other words, cannot pass into the interior of the machine.

The funnel-like liner is preferably releasably attached, thereby enabling a liner that has been completely soiled during intended proper use to be removed from the machine and cleaned or replaced.

The liner is in particular configured and designed so that the surrounding internal parts of the housing are shielded—in other words, no soiling of these internal housing parts can occur due to falling used grounds.

The invention especially preferably provides that the funnel-like liner is connected by a first wall in an at least virtually gap-free manner to the outlet of the brewing module.

The brewing module typically has a corresponding recess including wall sections that form the outlet or the discharge chute through which the used grounds are discharged. The funnel-like liner is connected by a first wall to this outlet, thereby precluding any soiling of the interior of the machine in this region.

In addition, the invention preferably provides that the funnel-like liner reach by a second wall opposite the first wall across a support edge of the housing or of the brewing module, and be supported thereon.

This arrangement first of all ensures that the funnel-like liner can be disposed in a predetermined intended position within a recess of the machine, where the funnel-like liner is both retained against the first wall at regions of the outlet, but also supported on a support edge of the housing, thereby achieving secure positioning.

The invention here preferably provides that a grip edge be provided on the second wall to enable the funnel-like liner to be manipulated.

This design enables the user to easily grasp the funnel-like liner by the grip edge so as to be able to remove this liner from the interior of the machine, for example, for cleaning purposes.

In order to achieve complete shielding of the machine interior from the used grounds, the invention also provides that the first and second walls of the funnel-like liner be interconnected by side walls.

Although it is possible to design the funnel-like liner in any shape desired, a roughly square design of this liner is preferred since this best matches the spatial restrictions within the corresponding apparatus.

In addition, the invention provides that at least one cross member or bar be provided in the passage for the used grounds that is created by the funnel-like liner, by which cross member the used grounds ejected from the outlet of the brewing module is broken up.

This design, which is considered to be an independent is inventive step, functions to divide the used grounds dropping from the brewing module so that these grounds are not deposited as a compact cake or disk in the used grounds receptacle and possibly be stacked one upon the other, thereby very quickly reaching the maximum fill level of the used grounds receptacle. Instead the caked used grounds are broken up by the cross member as they drop, with the result that a higher fill level for the used grounds receptacle can be achieved.

In addition, the invention provides here that the cross member be provide centrally within the passage of the funnel-like liner.

Preferably, the invention provides here that the cross member be provided on the back end region of the passage in the falling direction of the used grounds.

What is achieved thereby is that the dividing up of the used grounds does not occur at the inlet opening of the funnel-like element but instead close to its outlet region, where the region in which the cross member is disposed is completely surrounded by walls of the funnel-like liner, thereby precluding any soiling here of the surrounding parts of the machine.

In addition, the invention provides that the cross member form a grip for manipulating the funnel-like liner.

This design functions so as to enable the user as needed to remove the funnel-like liner by grasping the element by the cross member and thus removing it from the corresponding opening of the machine.

Optionally, the invention can preferably also provide that the cross member be of a sharp-edged design toward the outlet of the brewing module. This ensures effective division of the dropping used grounds.

In addition, the invention provides that the housing include a closable opening at the center of the housing part behind which the funnel-like liner is disposed and is accessible when the opening is exposed.

What is achieved thereby is that the installation opening, through which the funnel-like liner is accessible, is closed in the position of normal use for the apparatus—in other words, the interior of the machine is not visible.

### BRIEF DESCRIPTION OF THE DRAWING

The above and other objects, features, and advantages will become more readily apparent from the following description, reference being made to the accompanying drawing in which:

FIG. 1 is a perspective view of a back side of a coffee machine according to the invention; and

FIG. 2 is a perspective view showing only the waste-chute liner according to the invention.

### DETAILED DESCRIPTION

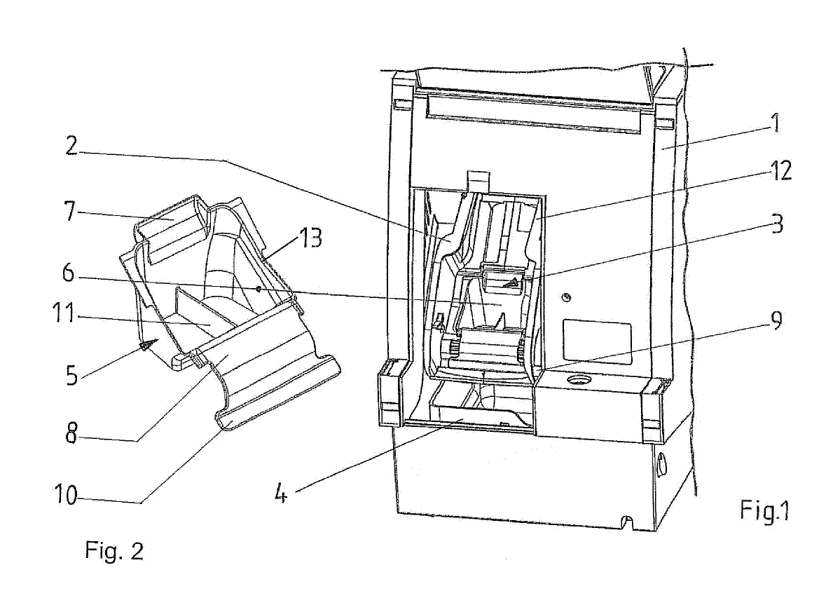

As seen in FIG. 1 an electric coffee machine has a housing 1 that receives diverse functional liners, a brewing module 2 is disposed in housing 1, the purpose of which is to receive, for example, ground coffee. The ground coffee received by the brewing module 2 is compressed and infused with hot water such that a hot beverage can be dispensed from the front side of the machine, not visible in the drawing. The brewing module 2 furthermore has a outlet 3 for used saturated beverage powder, here ground coffee, in the form of used grounds. When the brewing module 2 is opened and the ground coffee in the form of a used grounds disk or cake is ejected, it drops into a used grounds receptacle 4 disposed a certain spacing therebelow. The residual ground receptacle 4 is removable from the front side of the apparatus.

In order to prevent any internal parts of the apparatus from becoming soiled when the used grounds are ejected, a funnel-like component or liner 5 is inserted into the clearance created between the outlet and used grounds receptacle 4, as is shown by arrow 6. This funnel-like liner 5 is shown in FIG. 1 in its installed position. When thus installed, this liner covers the housing interior, protecting it from the dropping used grounds so that the housing interior and the components in the housing interior cannot be soiled by the used grounds but are instead shielded from them.

In particular, the funnel-like liner 5 is fitted without a gap by a first wall 7 to the outlet 3 of the brewing module 2. The second wall 8 opposite the first wall 7 is fitted over a support edge 9 of the housing 1 or of the brewing module 2, and is supported on this edge 9, thereby being solidly held in the intended installation position illustrated in FIG. 1.

In addition, the second wall 8 can form a grip edge 10 for manipulating the liner 5. This edge 10 can be grasped by the hand of the user to position or remove the funnel-like liner 5.

As is evident from FIG. 2, the first wall 7 and the second wall 8 are interconnected by a pair of parallel front-to-back side walls 13, thereby creating a square passage extending vertically from the outlet 3 to the receptacle 4.

A cross member or bar 11 extends across the passage for used grounds in the liner 5. Cakes of used grounds ejected from the outlet 3 of the brewing module 2 are broken up by this member 11 so that the grounds are dropped in smaller fragments into the used grounds receptacle 4, not in compact cake-like form but in crumbled form.

The cross member 11 is preferably provided at the center of the passage of the liner 5, specifically at the back end region of the passage in the falling direction of the used grounds. Thus the cross member 11 furthermore provides a grip for manipulating liner 5 so as to enable it to be removed or inserted into the intended position.

The cross member 11 preferably runs parallel to the side walls 13 of the funnel-like liner. In particular, the upper edge of cross member 11 facing the outlet 3 of the brewing module 2 has a sharp upwardly directed edge so as to facilitate the action of dividing up the falling used grounds.

Adjacent the liner 5, the housing 1 has a closable opening 12 behind which the liner 5 is disposed and that gives access to the liner 5 and receptacle 4 when the opening 12 is open. The opening 12 can be closed by an unillustrated cover so that the liner 5 and receptacle 4 are not visible during normal use.

The inventive design thus ensures that difficult-to-clean housing parts remain clean, and the liner 5 serving this purpose is easily removable and easy to clean. The cross member 11 is provided to break up the cakes of used grounds, and it can also be used to easily remove and manipulate the liner 5.

The invention is not restricted to the illustrated embodiment but can be varied in multiple ways within the scope of the disclosure. All novel features disclosed in the description and/or drawing, both individually and combined, are considered essential to the invention.

I claim:

1. An electric coffee machine comprising:
a housing;
a brewing unit in the housing having an outlet from which used grounds are ejected;
a removable receptacle in the housing spaced below the outlet and adapted to receive the ejected used grounds; and
a removable funnel-shaped liner in the housing between the outlet and the receptacle surrounding a pathway traveled by the used grounds when moving from the outlet to the receptacle, whereby the liner protects the machine from being soiled by the used grounds when moving from the outlet to the receptacle.

2. The coffee machine defined in claim 1, wherein the liner has a first wall connected without a gap to the outlet.

3. The coffee machine defined in claim 2, wherein the housing has a support edge and the liner has opposite the first wall a second wall sitting on the support edge of the housing.

4. The coffee machine defined in claim 3, wherein the second wall is formed as a grip for lifting the liner.

5. The coffee machine defined in claim 3, wherein the liner has a pair of spaced side walls interconnecting the first and second walls and forming therewith a passage through which the pathway extends.

6. The coffee machine defined in claim 5, wherein the liner is formed with a cross bar extending horizontally across the passage and through the pathway, whereby cakes of the used grounds dropping from the outlet are broken up by contact with the cross bar.

7. The coffee machine defined in claim 6, wherein the cross bar extends centrally across the passage.

8. The coffee machine defined in claim 6, wherein the cross bar is at a lower end of the passage.

9. The coffee machine defined in claim 6, wherein the bar forms a grip by means of which the liner can be manipulated.

10. The coffee machine defined in claim 6, wherein the bar extends generally parallel to the side walls.

11. The coffee machine defined in claim 6, wherein the bar has a sharp upper edge.

12. The coffee machine defined in claim 1, wherein the housing is formed adjacent the liner and receptacle with a closable opening through which access can be had to the liner and receptacle.

13. An electric coffee machine comprising:
a housing;
a brewing unit in the housing having a downwardly open outlet from which used grounds are ejected;
a removable receptacle in the housing spaced below the outlet and adapted to receive the ejected used grounds;
a removable funnel-shaped liner in the housing between the outlet and the receptacle and having a front wall fitted with the outlet, a pair of side walls projecting front to back from the side wall, and a back wall bridging the side walls, the walls defining a vertical passage and surrounding a pathway traveled by the used grounds when moving from the outlet to the receptacle, whereby the liner protects the machine from being soiled by the used grounds when moving from the outlet to the receptacle; and
a cross bar formed in the liner, extending horizontally front-to-back parallel to the side walls between the front wall and the back wall, and having a sharp upper edge, whereby cakes of the used grounds dropping from the outlet are broken up by the bar.
